(19) United States
(12) Patent Application Publication
(10) Pub. No.: US 2016/0072193 A1
(43) Pub. Date: Mar. 10, 2016

(54) Large Scale Phased Array Structure and Method of Fabrication

(71) Applicant: COMMONWEALTH SCIENTIFIC AND INDUSTRIAL RESEARCH ORGANISATION, Campbell (AU)

(72) Inventors: Anthony Ross Forsyth, Marsfield (AU); Robert Douglas Shaw, Marsfield (AU); Stuart Gifford Hay, Marsfield (AU)

(21) Appl. No.: 14/888,430

(22) PCT Filed: May 2, 2014
(86) PCT No.: PCT/AU14/00485

§ 371 Date: Oct. 31, 2015

(30) Foreign Application Priority Data
May 2, 2013 (AU) 2013901549

(51) Int. Cl. H01Q 21/00; H01Q 1/48

(52) U.S. Cl. CPC H01Q 21/0006; H01Q 1/48; H01Q 21/0093

(57) ABSTRACT

A phased array antenna device including: a conductive ground plane body structure including a series of through apertures; a structural spacing layer having known dielectric and structural properties, for holding an active layer in a predetermined stable spaced apart relationship to the ground plane body structure; a active surface layer spaced apart from the ground plane body structure and supported by said structural spacing layer, said active layer including a series of tile components, said tile components including a number of active conductive elements formed on a non conductive substrate, said active components being interconnected to corresponding driving electronics by conductive feeds formed through said apertures.

### FIELD OF THE INVENTION

The present invention relates to the field of antenna arrays and, in particular, discloses a method of fabrication of a large scale phased array antenna.

### BACKGROUND

Any discussion of the background art throughout the specification should in no way be considered as an admission that such art is widely known or forms part of common general knowledge in the field.

Operational requirements for large scale phased array antennas often call for a very large scale printed circuit board (PCB) arrangement of patterned active layer phased array elements.

Often, larger arrays exceed the limits of what is readily manufacturable. For example, modern PCB techniques generally extend to about 60 cm×60 cm boards. Projected phased array antennas are desirably of larger sizes. For example, 1.2 m×1.2 m, or even 5 m×5 m. There is therefore a desire to create ever larger phased arrays whilst utilising available technology.

### SUMMARY OF THE INVENTION

It is an object of the invention, in its preferred form to provide an improved form of large scale phase array antenna structure and methods of fabrication.

In accordance with a first aspect of the present invention, there is provided a phased array antenna device including: a conductive ground plane body structure including a series of through apertures; a structural spacing layer having known dielectric properties, for holding an active layer in a predetermined spaced apart relationship to the ground plane body structure; and an active surface layer spaced apart from the ground plane body structure and supported by said structural spacing layer, said active surface layer including a series of tile components, said tile components including a number of active conductive elements formed on a non conductive substrate, said active components being interconnected to corresponding connected electronics by conductive feeds formed through said apertures.

In some embodiments, the structural spacing layer is formed from a dielectric material having a predetermined suitable dielectric constant. The tile components can form a tiled array of elements. The tile components can be formed from a number of active components attached to a printed circuit board.

In some embodiments, the active layer is formed on a planar non-conductive structural supporting layer. In some embodiments, the active layer can be conformal to a third surface.

In accordance with a further aspect of the present invention, there is provided a method of construction of a phased array antenna device including the steps of: (a) forming a conductive ground plane body structure including a series of through apertures; (b) forming a structural spacing layer having known dielectric properties, for holding an active layer in a predetermined spaced apart relationship to the ground plane body structure; and (c) forming an active surface layer spaced apart from the ground plane body structure and supported by said structural spacing layer, said active layer including a series of tile components, said tile components including a number of active conductive elements formed on a non conductive substrate, said active components being interconnected to corresponding driving electronics by conductive feeds formed through said apertures.

### BRIEF DESCRIPTION OF THE DRAWINGS

Embodiments of the invention will now be described, by way of example only, with reference to the accompanying drawings in which:

FIG. 1 illustrates an exploded sectional view of a portion of a phased array device;

FIG. 2 illustrates a front plan view of a single tile including a number of conductive patches;

FIG. 3 illustrates a sectional view of the portion of the phased array device similar to that shown in FIG. 1;

FIG. 4 illustrates a sectional view through an enlarged tiled array phased array device;

FIG. 5 illustrates a front plan view of an enlarged tiled phased array device; and

FIG. 6 illustrates a sectional view of an alternative phased array structure including a further substrate for mating collections of tiles.

### DETAILED DESCRIPTION

The preferred embodiment provides for the construction of phased array radar devices of flexible size and structure including conformal arrays and non-planar arrays.

In the preferred embodiment, a planar array antenna device is formed from a stable mechanical structure, allowing the tiling of active planar components.

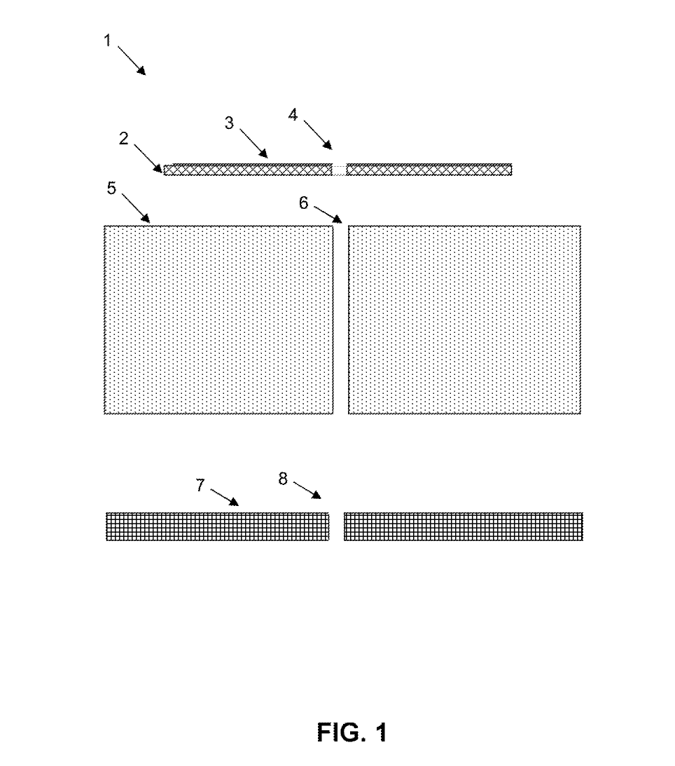

The initial structural components are shown in an exploded sectional schematic 1 in FIG. 1. They include an upper PCB 2 including a series of active components 3. The PCB 2 is formed in a tiled manner and may include a series of through hole vias 4 for the integration of vertical interconnect.

The PCB is designed to be integrated on the top of a dielectric material 5 that also provides structural stabilisation to the PCB. The dielectric material may be a polystyrene layer, foam layer, honeycombed structure or the like. Other materials can include Nomex or quartz cyanate ester. Where the need is required, it can be hollowed out to minimise any dielectric divergence from air conditions. The dielectric properties can be chosen for the application. The dielectric material can again include a series of through hole vias e.g. 6 for insertion of conductive wires.

The dielectric material is provided to allow for integration of electrical and mechanical properties to the antenna array.

A bottom layer 7 forms a conductive ground plane 7, again with the through hole vias e.g. 8 for the insertion of conductive wires.

The system provides a composite sandwich structure having a high shear stiffness and known dielectric properties. The various layers integrate both the structural and electrical properties of the array. The system also has the advantage that the top active layer can be simply modified or replaced.

The layers 2, 5, 7 can be bonded together to form an overall structural unit, with the through hole vias utilised to interconnect connected feed electronics placed behind the ground plane layer 7. The layers 5,7, form a structural support for the PCB 2. The PCB 2 can be formed in to a repetitive structure or tiled structure.

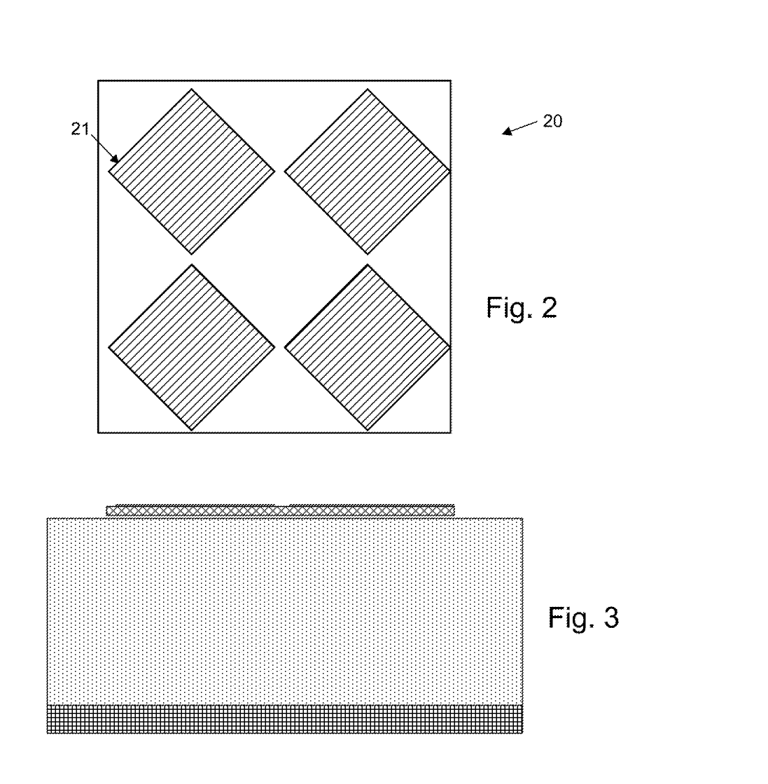

FIG. 2 illustrates an example of a tile component 20 of the top active layer. The component can be made of a number of conductive patches 21, which are connected at the corners with corresponding conductive wires (not shown). The conductive wires go through the ground plane to connected electronics. The conductive patches can be formed on the tile PCB as a separate operation. The tiles comprise a unit cell of radiating components on their active layer.

FIG. 3 illustrates the tile mounted on the dielectric substrate without the through hole interconnections.

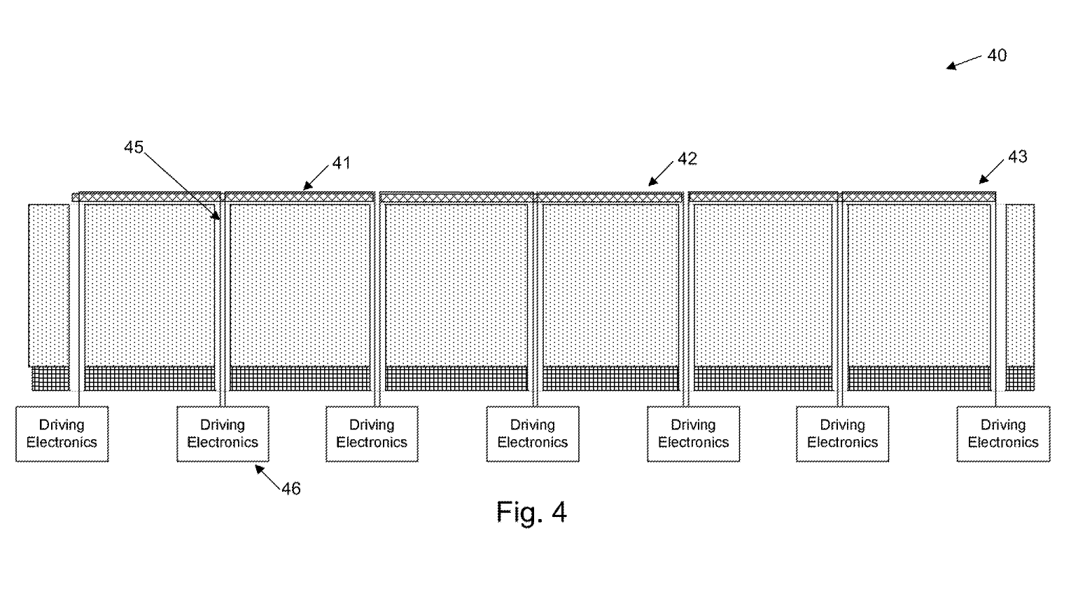

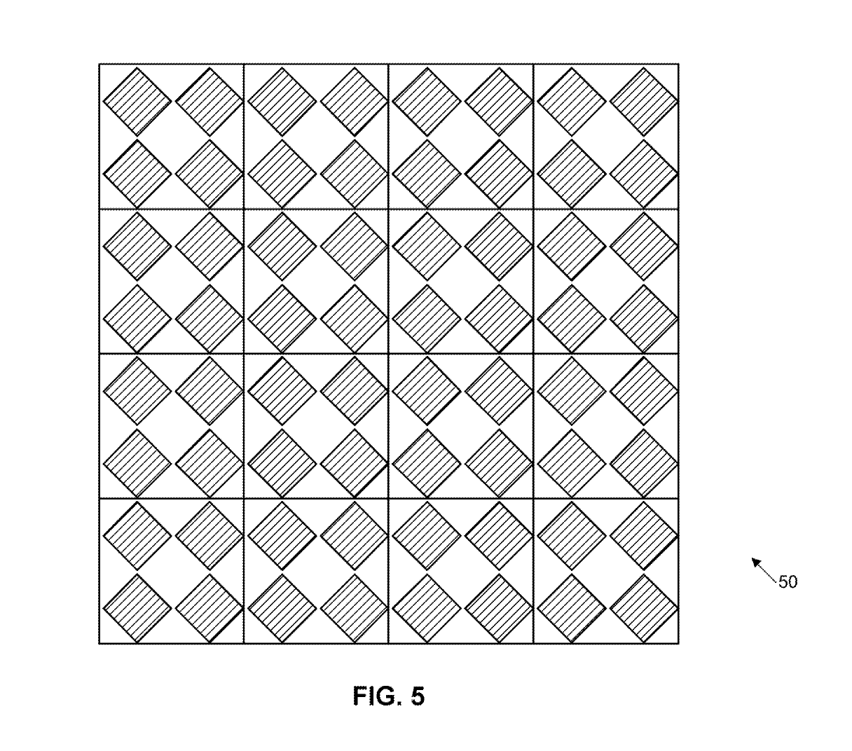

FIG. 4 illustrates a sectional view of an expanded arrangement with many tiles. The tiles 41-43 are abutted to one another and conductive interconnects e.g. 45 are formed through the vias thereby interconnecting the active layer with corresponding driving electronics e.g. 46.

The construction arrangement of the preferred embodiment allows for large tiled array phased array antennas to be built. In the illustrated embodiment, the tiled array has self complementary properties.

An example of the tiling process is illustrated in FIG. 5 where the large phased array 50 is made up of many tiled components of a form similar to that disclosed in FIG. 2.

Ideally, when constructing such arrangements, no conductive interconnects are provided between tiles.

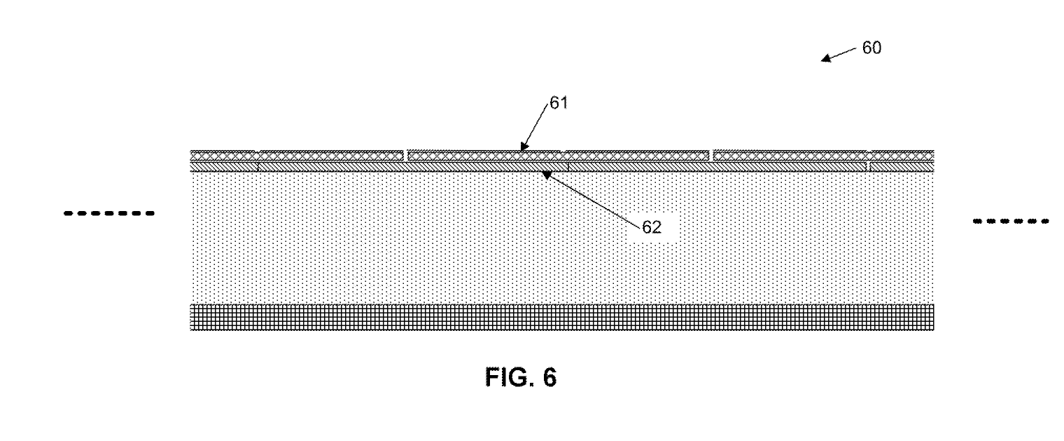

Further modifications are contemplated. For example, where even larger tile arrangements are contemplated, extra structural support layers can be included. For example, in FIG. 6, there is illustrated a modified arrangement 60 where the tiles 61, including the active components, are formed on a reinforcing substrate 62.

The utilization of a reinforced substrate further extends the possibilities of sizes of array structures. The tile and reinforced structure also allows for the possibility of non planar conformal designs where the tiles conform to a desired surface structure. This allows for shaped receivers to be utilised, for example in offset Gregorian feed type antennas and other feeds where the focal plane of energy is non planar.

The tiled approach provides a significant reduction in complexity limitations on fabricating large number of active antenna elements leading to improved manufacturability of large-scale arrays. The structural layers can be almost unlimited in size since there are no active elements. The only active elements are located on the similar upper layer tiles which individually are much smaller than the antenna aperture and much simpler and cheaper to manufacture within required tolerances. The tiled active layer on the substrate provides significantly improved tolerance for failure rejection as each individual tile includes a single (or small number) of active antenna elements can be tested and discarded individually.

Another significant advantage of the preferred embodiment is that the active surface layer can be modified independently of the other layers, and provided the position of conductive interconnects are maintained, a new active surface layer can be retrofitted into an old array. This is particularly advantageous when the arrangements of components on the active layer is evolving with continuous research and the designs are being updated to provide improved qualities or differing requirements.

### Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other, including in an electromagnetic coupling.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A phased array antenna device, comprising:
a conductive ground plane body structure comprising a series of through apertures;
an active surface layer, said active surface layer comprising a series of tile components, said tile components comprising a plurality of active conductive elements formed on a non conductive substrate, said plurality of active conductive elements being interconnected to corresponding driving electronics by conductive feeds formed through said apertures; and
a structural spacing layer configured to hold said active surface layer in a predetermined spaced apart relationship to said ground plane body structure.

2. The phased array antenna device of claim 1, wherein said structural spacing layer is formed from a dielectric material having predetermined dielectric properties.

3. The phased array antenna device of claim 1, wherein said series of tile components form a tiled array of elements.

4. (canceled)

5. The phased array antenna device of claim 1, wherein said active surface layer is formed on a planar non-conductive structural supporting layer.

6. (canceled)

7. A method for forming a phased array antenna device, comprising the steps of:
(a) providing a conductive ground plane body structure including comprising a series of through apertures;
(b) providing an active surface layer, said active layer including a series of tile components, said tile components including a plurality of active conductive elements formed on a non conductive substrate, said active conductive elements being interconnected to corresponding driving electronics by conductive feeds formed through said apertures; and
(c) providing a structural spacing layer; and
(d) positioning said active surface layer in a predetermined spaced apart relationship to said ground plane body structure with said structural spacing layer.

8. (canceled)

9. The method of claim 7, further comprising forming a continuous layer between said structural spacing layer and said active surface layer to support said active surface layer.

10. A method for manufacturing large phased array antenna systems, the method comprising the steps of:
(a) fabricating a first plurality of active array elements; and
(b) forming a multilayer circuit structure, said multilayer circuit structure comprising a first active layer, a dielectric layer, and a substrate layer, wherein said first active layer comprises a second plurality of said first plurality of active array elements arranged in a tiled relationship on said dielectric layer to form a phased array antenna.

11. The method of claim 10, wherein said first plurality of active array elements comprise a multi-layer printed circuit board structure comprising a structural layer and a second active layer, said second active layer comprising printed circuit elements.

12. The method of claim 11, wherein said printed circuit elements comprise at least one active antenna element and power circuit elements, said power circuit elements being configured to supply power to and receive signals from said at least one of said first plurality of active array elements and connection to power circuit elements of adjacent active array elements when assembled to form a phased array antenna.

13-14. (canceled)
